(19) United States
(12) Patent Application Publication
(10) Pub. No.: US 2014/0094071 A1
(43) Pub. Date: Apr. 3, 2014

(54) COMPRESSIBLE PIN ASSEMBLY HAVING FRICTIONLESSLY CONNECTED CONTACT ELEMENTS

(71) Applicant: Corad Technology Inc., (US)

(72) Inventor: Ka Ng Chui, Menlo Park, CA (US)

(73) Assignee: CORAD TECHNOLOGY INC., Santa Clara, CA (US)

(21) Appl. No.: 13/644,125

(22) Filed: Oct. 3, 2012

(51) Int. Cl. H01R 13/17

(52) U.S. Cl. 439/884

(57) ABSTRACT

A compressible contact pin. The contact pin includes a first contact element and a second contact element. A compressible member is coupled between the first contact element and the second contact element to compress when one or more external forces are applied between the first contact element and the second contact element. In addition, the compressible member maintains a separation distance between the first and second contact elements when no external forces are applied. A deformable conductor is electrically coupled between the first contact element and the second contact element. The deformable conductor maintains the electrical coupling between the first contact element and the second contact element by deforming when the one or more external forces are applied between the first contact element and the second contact element.

### TECHNICAL FIELD

The present invention relates generally to compressible contact pins used in the testing of electronic devices, and specifically to a compressible pin assembly having frictionlessly connected contact elements.

### BACKGROUND OF RELATED ART

Pogo pins are often used in the testing of integrated circuit (IC) devices. IC packages typically have a number of contact pads, which serve as an interface or connection point to external circuitry. These contact pads are very small and delicate. Thus, a testing apparatus, used to test the function or performance of an IC device, must be able to make contact with one or more contact pads on the IC device without damaging the pads. Otherwise, the device may be rendered unusable for its intended purpose. The design and compressibility of pogo pins allow them to make contact with an IC device or a contact pad on the device.

FIG. 1 illustrates a prior art embodiment of a typical pogo pin. The pogo pin 100 is made up of two contact elements 110 and 120, held together by a spring 130 and a housing 140. The first contact element 110 is designed to make a secure contact with a contact pad of an IC device. The second contact element 120 can be connected to circuitry on a testing apparatus. The first and second contact elements 110 and 120 are electrically coupled together via the housing 140 to bridge a connection between the ends of the pogo pin 100 so that electrical signals can be transmitted between the testing apparatus and the IC device.

When the pogo pin 100 is sandwiched between an IC device and a testing apparatus, the spring 130 compresses to exert force on the contact pad of the IC device by the first contact element 110. However, in order to maintain an electrical connection between the IC device and the testing apparatus, the first and second contact elements 110 and 120 must remain in constant contact with the housing 140, regardless of the amount of compression or displacement caused by the force of contact with the underlying IC device. Accordingly, the first and second contact elements 110 and 120 must rub against the inner wall of the housing 140, creating contact resistance, as the pogo pin 100 is compressed and decompressed. The friction between the first and second contact elements 110 and 120 and the housing 140 causes wear and tear on the surfaces 150 where each of the first and second contact elements 110 and 120 makes contact with the housing 140. This, in turn, increases the contact resistance. Such wear and tear, along with the increased contact resistance, can reduce the signal quality transmitted by the pogo pin 100 over time.

Accordingly, there is a need for a compressible contact pin that can withstand continued use without loss of signal quality. More specifically, there is a need for a compressible contact pin comprised of frictionlessly connected contact elements, so that the contact pin can be compressed and decompressed without substantial wear and tear on its parts and/or increased contact resistance.

### BRIEF DESCRIPTION OF THE DRAWINGS

The present embodiments are illustrated by way of example and not intended to be limited by the figures of the accompanying drawings, where:

FIG. 1 illustrates a prior art embodiment of a pogo pin;

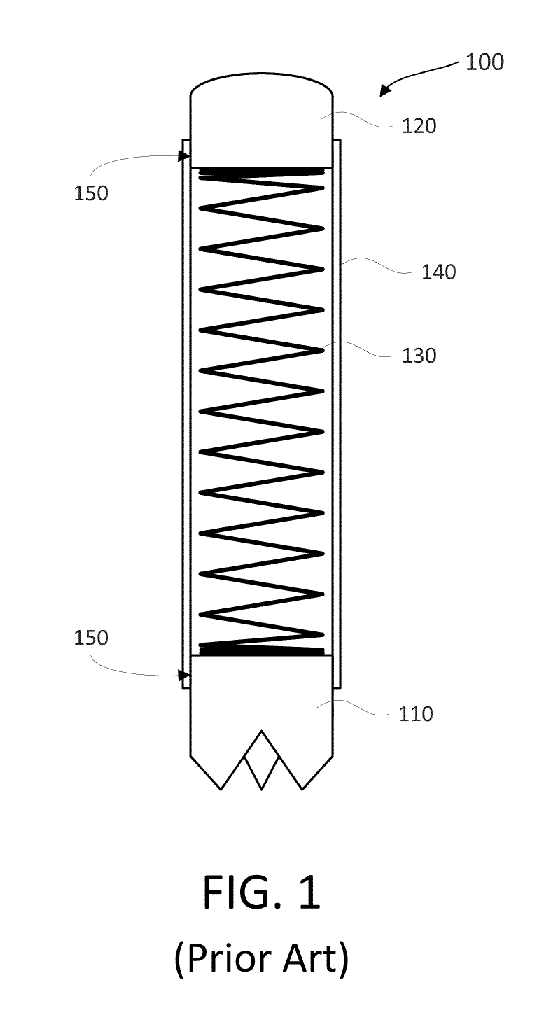

FIGS. 2A & 2B illustrate an embodiment of a compressible contact pin having frictionlessly connected contact elements;

FIG. 3 illustrates another embodiment of a compressible contact pin having frictionlessly connected contact elements;

FIGS. 4A & 4B illustrate an embodiment of a compressible contact pin assembly;

FIGS. 5A & 5B illustrate another embodiment of a compressible contact pin assembly;

Like reference numerals refer to corresponding parts throughout the drawing figures.

### DETAILED DESCRIPTION

A compressible contact pin having frictionlessly connected contact elements is disclosed. In the following description, for purposes of explanation, specific nomenclature is set forth to provide a thorough understanding of the present invention. However, it will be apparent to one skilled in the art that these specific details may not be required to practice the present invention. In some instances, the interconnection between circuit elements may be shown as buses or as single signal lines. Each of the buses may alternatively be a single signal line, and each of the single signal lines may alternatively be a bus. As used herein, references to “frictionless” or “frictionlessly” may refer to an absence of surface-to-surface contact or rubbing when two or more components are moveably coupled to one another. Furthermore, the terms “contact pad” and “contact bump” may be used herein interchangeably. Accordingly, the present invention is not to be construed as limited to specific examples described herein but rather includes within its scope all embodiments defined by the appended claims.

Present embodiments provide a compressible contact pin having no contact force on the moving parts along its signal path. The contact elements of the compressible contact pin are frictionlessly coupled together so that the surfaces of the contact elements do not rub against or make contact with any other surfaces of the compressible contact pin as the pin is compressed and decompressed. In specific embodiments, a compressible contact pin includes two contact elements connected via a deformable conductor that flexes or bends when the contact pin is compressed. Other embodiments provide for a contact pin assembly, wherein a compressible contact pin is disposed in a housing that provides structural support for the contact pin and prevents lateral movement of the contact elements.

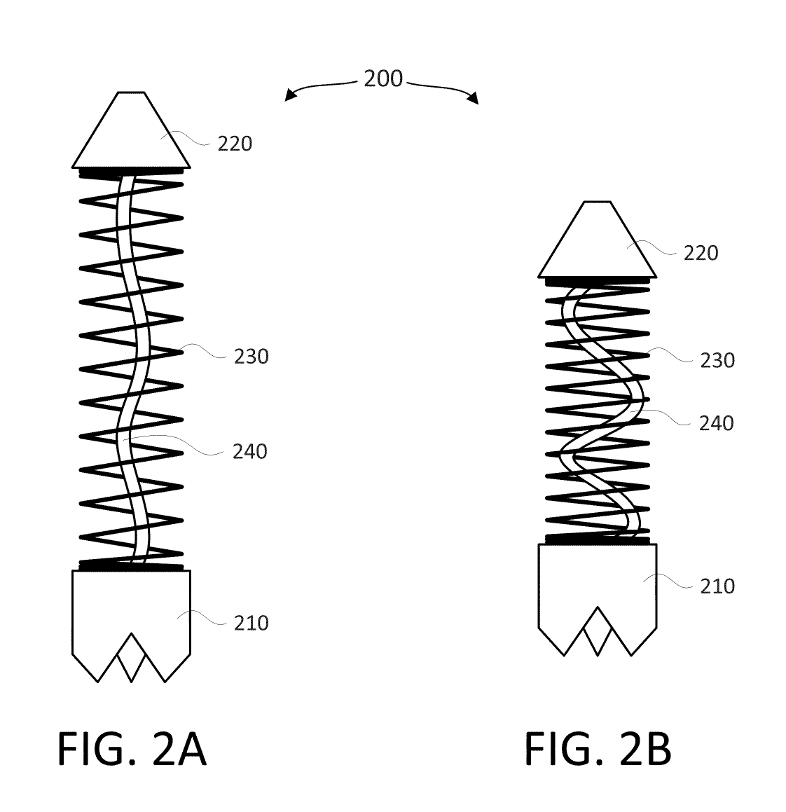

FIGS. 2A & 2B illustrate an embodiment of a compressible contact pin having frictionlessly connected contact elements. The compressible contact pin 200 includes a first contact element 210, a second contact element 220, a compressible member 230, and a deformable conductor 240. In some embodiments, the shape or geometry of the first contact element 210 is designed to allow the first contact element 210 to make contact with a contact pad (or contact “bump”) of an IC device. Similarly, the shape of the second contact element 220 may be designed to allow the second contact element 220 to make contact with the circuitry of a testing apparatus.

The compressible member 230 maintains a separation distance between the first and second contact elements 210 and 220, thus extending the “reach” of the contact pin 200 when the contact pin 200 is in a “natural” or uncompressed state. In addition, the compressible member 230 absorbs some of the force exerted by one or more of the contact elements 210 and 220 when making contact with an IC device or testing apparatus. For example, when the first contact element 210 is brought into contact with a contact pad of an IC device or package, the compressible member 230 compresses to allow an inward travel of the first contact element 210, as shown in FIG. 2B. This causes the first contact element 210 to exert a force on the contact pad of an underlying IC device in order to form a robust contact and/or connection with the contact pad. When the first contact element 210 is no longer pressed against the contact pad of an IC device, the compressible member 230 reverts back to its natural, uncompressed state.

The deformable conductor 240 electrically couples the first contact element 210 with the second contact element 220 to facilitate a flow of electrical signals (or current) between the first and second contact elements 210 and 220. As shown in FIG. 2B, the deformable conductor 240 “deforms” (e.g., flexes or bends) when the contact pin 200 is compressed. This allows the first contact element 210 to remain electrically coupled to the second contact element 220 regardless of the degree of compression of the contact pin 200. Moreover, compression of the contact pin 200 does not create any friction among the contact elements 210 and 220 or deformable conductor 240 because no surfaces of the first and second contact element 210 and 220, or deformable conductor 240, rub against any other surfaces of the compressible contact pin 200.

In some embodiments, the compressible member 230 may be a spring or spring-like structure that compresses under external forces or pressure, but naturally reverts to an uncompressed state when no external force is applied. Furthermore, the compressible member 230 may be formed from (or coated with) a non-conductive material that does not interfere with a flow of electrical signals between the first and second contact elements 210 and 220. In other embodiments, the compressible member 230 simply has a higher electrical impedance than that of the deformable conductor 240 to ensure that electrical signals communicated between the first and second contact elements 210 and 220 travel only along the deformable conductor 240. The compressible member 230 may be attached to the first and second contact elements 210 and 220 using any number of processes that are well known in the art. For example, each of the contact elements 210 and 220 may be attached to a different end of the compressible member 230 using an adhesive material (e.g., glue). Alternatively, the ends of the compressible member 230 may be soldered to each of the first and second contact elements 210 and 220.

In some embodiments, the deformable conductor 240 may be structurally configured to deform when an external force is applied. Alternatively, the deformable conductor 240 may be of a conductive material that naturally deforms when compressed, such as a copper wire. The deformable conductor 240 may be separately attached to the first and second contact elements 210 and 220 using any number of processes that are well known in the art. For example, the ends of the deformable conductor 240 may be soldered to the first and second contact elements 210 and 220, respectively.

The frictionless coupling of the first and second contact elements 210 and 220 is advantageous because it reduces the wear and tear along the signal path of the compressible contact pin 200, thus preserving the signal integrity of electrical signals transmitted via the contact pin 200 after repeated uses. This, in turn, prolongs the usable life of the compressible contact pin 200.

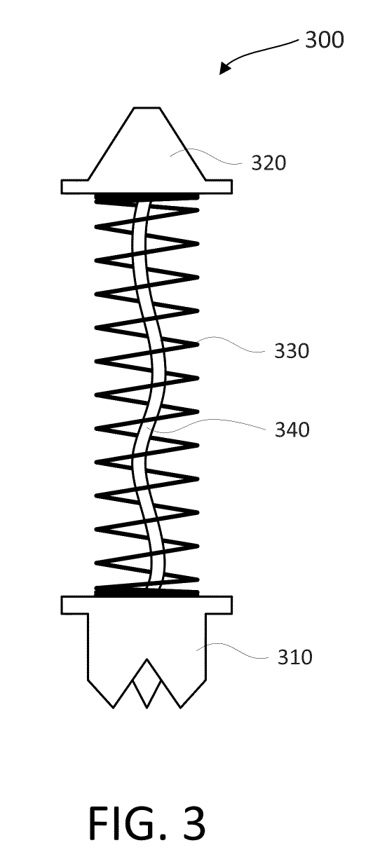

FIG. 3 illustrates another embodiment of a compressible contact pin having frictionlessly connected contact elements. The compressible contact pin 300 includes a first contact element 310, a second contact element 320, a compressible member 330, and a deformable conductor 340. The first and second contact elements 310 and 320 are mechanically coupled via the compressible member 330, which maintains a distance of separation between the first and second contact elements 310 and 320 when the contact pin 300 is in an uncompressed state. The deformable conductor 340 electrically couples the first contact element 310 with the second contact element 320 to facilitate a flow of electrical signals between the first and second contact elements 310 and 320.

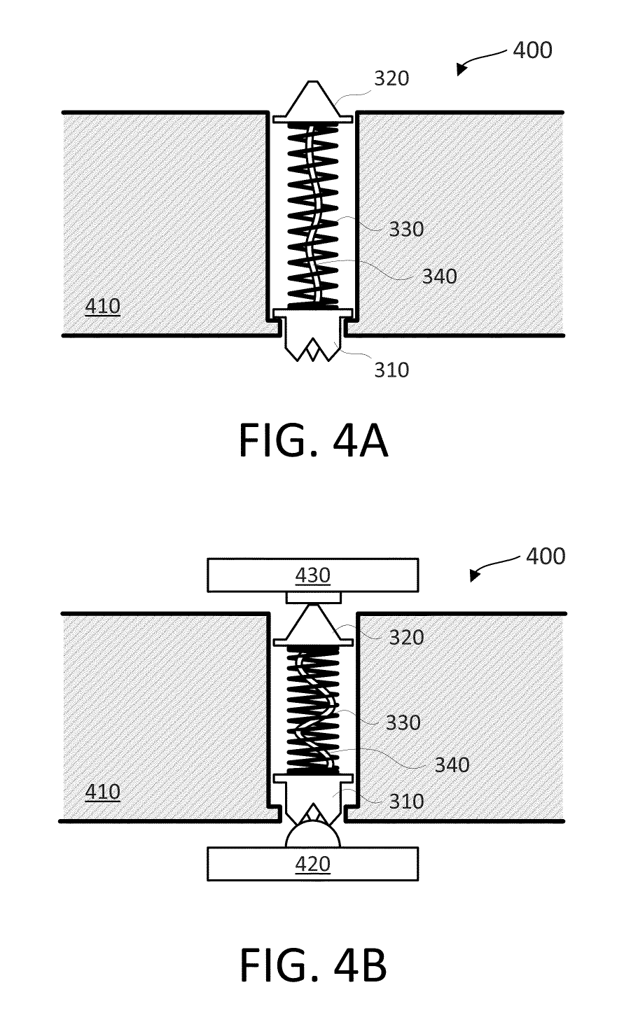

The shape of the first contact element 310 may be designed to allow the first contact element 310 to make contact with a contact pad of an IC device. In an embodiment, the base of the first contact element 310 (e.g., where the deformable conductor 340 attaches) has an extended lip that may be used to hold the contact pin 300 within a housing or support structure, as will be discussed in greater detail with respect to FIGS. 4A & 4B. In addition, the extended lip may reduce the overall wear and tear on the first contact element 310 as it moves within the housing. The shape of the second contact element 320 may be designed to allow the second contact element 320 to make contact with the circuitry of a testing apparatus. According to an embodiment, the base of the second contact element 320 also has an extended lip that may be used to hold the contact pin 300 within a housing and/or reduce wear and tear while moving within the housing.

FIG. 4A illustrates an embodiment of a compressible contact pin assembly. The contact pin assembly 400 includes a first contact element 310, a second contact element 320, a compressible member 330, a deformable conductor 340, and a housing 410. The first and second contact elements 310 and 320, compressible member 330, and deformable conductor 340 collectively form the compressible contact pin 300 shown in FIG. 3. The housing 410 holds the contact pin 300 in place when interfacing a testing apparatus with an IC device. For example, the bottom surface of the housing 410 may have a opening that is not wide enough for the base of the first contact element 310 to fit through. In addition, the housing 410 provides structural support for the compressible contact pin 300 by guiding the movement or displacement of the first and second contact elements 310 and 320.

FIG. 4B shows the contact pin assembly of FIG. 4A with the compressible contact pin 300 in a compressed state. As shown in FIG. 4B, the second contact element 320 makes contact with a testing apparatus 430, and the first contact element 310 is brought into contact with a contact bump of an IC device 420. This causes the compressible member 330 to compress, thus causing the first contact element 310 to exert a force on the contact bump of the IC device 420. The deformable conductor 340 also deforms (e.g., flexes or bends) when the compressible member 330 compresses. Accordingly, the deformable conductor 340 maintains an electrical connection between the first contact element 310 and the second contact element 320 without causing any surfaces of the first and second contact elements 310 and 320, or deformable conductor 340, to rub against any other surfaces of the compressible contact pin 300. The deformable conductor 340 thus facilitates the transmission of electrical signals between the testing apparatus 430 and the IC device 420 without substantial wear or tear.

In some embodiments, the compressible member 330 may be a spring or spring-like structure that compresses under external forces or pressure, but naturally reverts to an uncompressed state when no external force is applied. Furthermore, the compressible member 330 may be formed from a non-conductive material. Alternatively, the compressible member 330 may have a higher electrical impedance than that of the deformable conductor 340. The compressible member 330 may be attached to the first and second contact elements 310 and 320 using any number of processes that are well known in the art. For example, each of the contact elements 310 and 320 may be attached to a different end of the compressible member 330 using an adhesive material (e.g., glue). Alternatively, the ends of the compressible member 330 may be soldered to the first and second contact elements 310 and 320.

In some embodiments, the deformable conductor 340 may be structurally configured to deform when an external force is applied. Alternatively, the deformable conductor 340 may be of a conductive material that naturally deforms when compressed, such as copper wire. The deformable conductor 340 may be separately attached to the first and second contact elements 310 and 320 using any number of processes that are well known in the art. For example, the ends of the deformable conductor 340 may be soldered to the first and second contact elements 310 and 320.

In some embodiments, the housing 410 may be formed from a non-conductive/dielectric material. Furthermore, the housing 410 may be configured to hold multiple compressible contact pins similar to the compressible contact pin 300 shown in FIG. 3. For example, the contact pin assembly 400 may correspond to the probe head associated with a probe card.

The frictionless coupling of the first and second contact elements 310 and 320 is advantageous because it reduces the wear and tear along the signal path of the compressible contact pin 300, thus preserving the signal integrity of electrical signals transmitted via the contact pin 300 after repeated uses. In addition, the housing 410 maintains the structural rigidity of the contact pin assembly 400 while also restricting lateral movement and/or displacement of the first and second contact elements 310 and 320 when making contact with the IC device and testing apparatus, respectively.

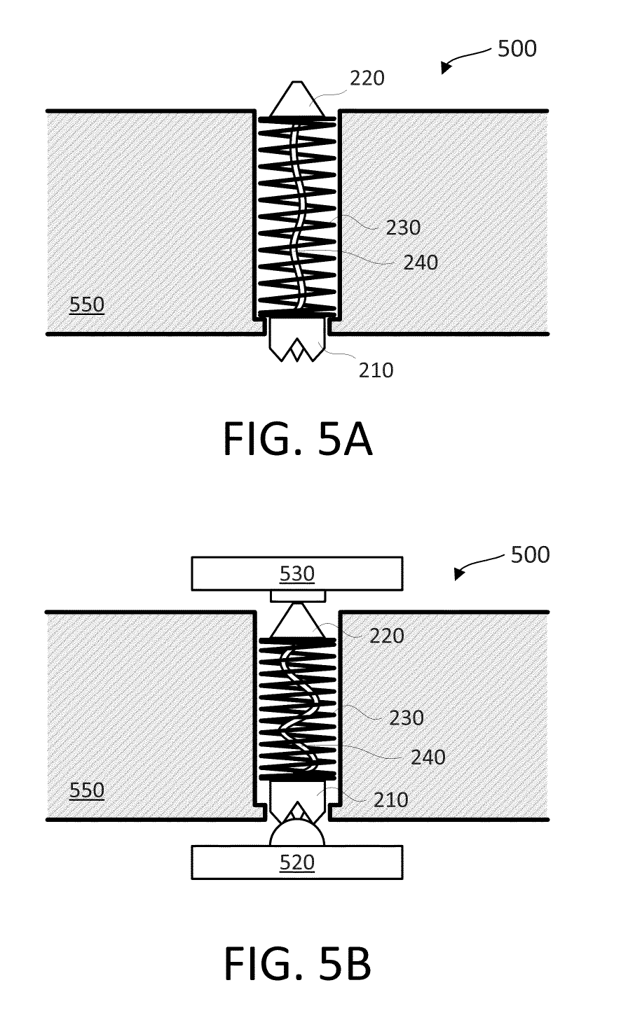

FIG. 5A illustrates another embodiment of a compressible contact pin assembly. The contact pin assembly 500 includes a first contact element 210, a second contact element 220, a compressible member 230, a deformable conductor 240, and a housing 550. The first and second contact elements 210 and 220, compressible member 230, and deformable conductor 240 collectively form the compressible contact pin 200 described above with respect to FIGS. 2A & 2B. However, in this embodiment, the compressible member 230 has a wider diameter relative to the diameter of the contact elements 210 and 220. The housing 550 holds the contact pin 200 in place when interfacing a testing apparatus with an IC device. For example, the bottom surface of the housing 550 may have a opening that is not wide enough for the compressible member 230 to fit through. In addition, the housing 550 provides structural support for the compressible contact pin 200 by guiding the movement or displacement of the first and second contact elements 210 and 220.

FIG. 5B shows the contact pin assembly of FIG. 5A with compressible contact pin 200 in a compressed state. As shown in FIG. 5B, the second contact element 220 makes contact with a testing apparatus 530, and the first contact element 210 is brought into contact with a contact bump of an IC device 520. This causes the compressible member 230 to compress, thus causing the first contact element 210 to exert a force on the contact bump of the IC device 520. The deformable conductor 240 also deforms (e.g., flexes or bends) when the compressible member 230 compresses. Accordingly, the deformable conductor 240 maintains an electrical connection between the first contact element 210 and the second contact element 220 without causing any surfaces of the first and second contact elements 210 and 220, or deformable conductor 240, to rub against any other surfaces of the compressible contact pin 200.

In some embodiments, the compressible member 230 may be a spring or spring-like structure that compresses under external forces or pressure, but naturally reverts to an uncompressed state when no external force is applied. Furthermore, the compressible member 230 may be formed from a non-conductive material. Alternatively, the compressible member 230 may have a higher electrical impedance than that of the deformable conductor 240. The compressible member 230 may be attached to the first and second contact elements 210 and 220 using any number of processes that are well known in the art. For example, each of the contact elements 210 and 220 may be attached to a different end of the compressible member 230 using an adhesive material. Alternatively, the ends of the compressible member 230 may be soldered to the first and second contact elements 210 and 220.

In some embodiments, the deformable conductor 240 may be structurally configured to deform when an external force is applied. Alternatively, the deformable conductor 240 may be of a conductive material that naturally deforms when compressed, such as copper wire. The deformable conductor 240 may be separately attached to the first and second contact elements 210 and 220 using any number of processes that are well known in the art. For example, the ends of the deformable conductor 240 may be soldered to the first and second contact elements 210 and 220.

In some embodiments, the housing 550 may be formed from a non-conductive/dielectric material. Furthermore, the housing 550 may be configured to hold multiple compressible contact pins.

While particular embodiments have been shown and described, it will be obvious to those skilled in the art that changes and modifications may be made without departing from this disclosure in its broader aspects and, therefore, the appended claims are to encompass within their scope all such changes and modifications as fall within the true spirit and scope of this disclosure.

Further, it should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, non-volatile storage media in various forms (e.g., optical, magnetic or semiconductor storage media).

What is claimed is:

1. A contact pin, comprising:
a first contact element;
a second contact element;
a compressible member coupled between the first contact element and the second contact element to compress when one or more external forces are applied between the first contact element and the second contact element, and to maintain a separation distance between the first and second contact elements when no external forces are applied; and
a deformable conductor electrically coupled between the first contact element and the second contact element, wherein the deformable conductor maintains the electrical coupling between the first contact element and the second contact element by deforming when the one or more external forces are applied between the first contact element and the second contact element.

2. The contact pin of claim 1, wherein the deformable conductor enables the first contact element to remain frictionlessly coupled to the second contact element as the one or more external forces are applied between the first contact element and the second contact element.

3. The contact pin of claim 1, wherein the deformable conductor bends or flexes when the one or more external forces are applied between the first contact element and the second contact element.

4. The contact pin of claim 1, wherein the deformable conductor comprises a conductive wire.

5. The contact pin of claim 1, wherein the compressible member comprises a spring.

6. The contact pin of claim 1, wherein the impedance of the compressible member is greater than the impedance of the deformable conductor.

7. A contact pin comprising:
a first contact element;
a second contact element electrically coupled to the first contact element;
a compressible member coupled between the first contact element and the second contact element to compress when one or more external forces are applied between the first contact element and the second contact element, and to maintain a separation distance between the first and second contact elements when no external forces are applied; and
wherein the first contact element remains frictionlessly connected to the second contact element as the one or more external forces are applied between the first contact element and the second contact element.

8. The contact pin of claim 7, further comprising a deformable conductor electrically coupled between the first contact element and the second contact element, wherein the deformable conductor is configured to deform when the one or more external forces are applied between the first contact element and the second contact element.

9. The contact pin of claim 8, wherein the deformable conductor bends or flexes when the one or more external forces are applied between the first contact element and the second contact element.

10. The contact pin of claim 8, wherein the deformable conductor comprises a conductive wire.

11. The contact pin of claim 8, wherein the impedance of the compressible member is greater than the impedance of the deformable conductor.

12. The contact pin of claim 7, wherein the compressible member comprises a spring.
